(19) United States
(12) Patent Application Publication
(10) Pub. No.: US 2013/0036586 A1
(43) Pub. Date: Feb. 14, 2013

(54) ATTACHMENT JIG FOR ATTACHING SELF-PROPELLED DEVICE TO ENDOSCOPE

(71) Applicants: Takayuki NAKAMURA, Kanagawa (JP); Tsuyoshi Ashida, Kanagawa (JP); Yasunori Ohta, Kanagawa (JP); Shinichi Yamakawa, Kanagawa (JP); John J. Allen, Mendota Heights, MN (US)

(72) Inventors: Takayuki NAKAMURA, Kanagawa (JP); Tsuyoshi Ashida, Kanagawa (JP); Yasunori Ohta, Kanagawa (JP); Shinichi Yamakawa, Kanagawa (JP); John J. Allen, Mendota Heights, MN (US)

(73) Assignee: FUJIFILM Corporation, Tokyo (JP)

(21) Appl. No.: 13/571,483

(22) Filed: Aug. 10, 2012

Related U.S. Application Data
(60) Provisional application No. 61/522,996, filed on Aug. 12, 2011.

(51) Int. Cl. B25B 27/14

(52) U.S. Cl. 29/270

(57) ABSTRACT

An attachment jig includes a cylinder portion at one end of which a ring portion for fixing a self-propelled device to an endoscope is provided, and a handle portion which is provided at the other end of the cylinder portion and is gripped so as to rotate the cylinder portion. An O ring is brought into press-contact with the outer periphery of an insertion section of the endoscope, such that the self-propelled device is fixed to the insertion section. When the handle portion is further turned, a thin-walled breaking portion is broken, and the ring portion is separated from the cylinder portion. When the handle portion is rotated in an opposite direction, the cylinder portion is taken out from the insertion section, while the ring portion remains in the fixed position.

### BACKGROUND OF THE INVENTION

1. Field of the Invention

The present invention relates to an attachment jig for attaching a self-propelled device to an insertion section of an endoscope, the self-propelled device assisting insertion of the insertion section into a body cavity.

2. Description of the Related Art

An endoscope has been widely used for examination of a body cavity of a patient. The endoscope has an insertion section to be inserted into a body cavity, and a manipulation section to be gripped by an operator. The insertion section consists of a short tip end rigid portion provided at the tip end thereof, a bending portion which is continuously provided at the base end of the tip end rigid portion and can be bent at will in order to turn the tip end rigid portion in a desired direction, and a long (about 1 m to 2 m, varying depending on application) flexible tube portion continuously provided at the base end of the bending portion. An image capturing window for capturing an image of a part to be observed inside a body cavity, and the like, are arranged at the front face of the tip end rigid portion.

In endoscopic examination of the large intestine, insertion of an endoscope into the large intestine is very difficult, since the large intestine has a meandering structure in the body, and the large intestine has parts that are not fixed inside the body. Therefore, a great deal of experience is required to master the technique for insertion of the endoscope into the large intestine, and if the insertion technique is unskilled, the insertion procedure can be very painful for a patient.

There is known a self-propelled device that is attached to a tip end rigid portion of an insertion section in order to assist insertion of the insertion section into a body cavity. The self-propelled device has a movable body which is formed in the shape of a hollow toroid (in the shape of a doughnut) from a flexible sheet-like material, and rotates (for example, refer to Japanese Patent Translation Publication No. 2009-513250).

The self-propelled device includes a driving unit that is fixed to the tip end rigid portion of the endoscope, and a toroid unit that is supported by the driving unit and exposes the movable body in the shape of toroid to the outer surface thereof. The movable body receives a driving force from the inner peripheral side thereof through the driving mechanism of the driving unit to perform a circulation movement, and the outer peripheral side thereof comes into contact with an inner wall of the body cavity sequentially, so as to apply a propulsive force to the tip end rigid portion.

Naturally, the self-propelled device is required to be firmly fixed to the tip end rigid portion such that the propulsive force thereof is efficiently transmitted and such that the self-propelled device does not come off the endoscope during use. Additionally, it is desirable that the attachment operation of the self-propelled device be easy. Further, since the self-propelled device is detached from the endoscope such that the endoscope can be washed and disinfected after the endscope is used, it is desirable that the detachment operation of the self-propelled device also be easy. In order to attach the self-propelled device to the tip end rigid portion, there are some attachment methods including screwing, press-fitting, bayoneting, engagement of a locking claw, and the like. However, in these attachment methods, there arise problems such as a large attachment space being required, detachment operation being troublesome, and parts deforming due to excessive fastening.

### SUMMARY OF THE INVENTION

An object of the present invention is to provide an attachment jig capable of easily attaching and detaching a self-propelled device to and from an endoscope.

In order to achieve the above and other objects, an attachment jig of the present invention includes a cylinder portion, a ring portion, and a handle portion. The attachment jig is used to fix a self-propelled device to a tip end of an insertion section of an endscope. The cylinder portion is inserted into a gap formed between an outer peripheral surface of the insertion section and an inner peripheral surface of the self-propelled device from the tip end side of the insertion section, in a state that the insertion section is inserted into the self-propelled device. The ring portion is separably provided at a first end of the cylinder portion, and fixes the self-propelled device to the insertion section at a fixed position. The handle portion is provided at a second end of the cylinder portion, and serves for moving the ring portion to the fixed position, separating the ring portion from the cylinder portion at the fixed position, and taking out the cylinder portion from the insertion section while leaving the ring portion at the fixed position.

The insertion section has a tip end rigid portion at its tip end. The self-propelled device is preferably fixed to the tip end rigid portion with the intermediation of the ring portion.

The ring portion preferably has an elastic member attached to its front end. The elastic member is pinched between the ring portion and a part of the self-propelled device and elastically deformed at the fixed position so as to be pressed against an outer peripheral surface of the tip end rigid portion. The elastic member is preferably an O ring made of rubber.

Preferably, the attachment jig further includes an external thread formed at an outer periphery of the cylinder portion. The external thread is threadedly engaged with an internal thread formed at the inner peripheral surface of the self-propelled device, such that the cylinder portion becomes movable toward the fixed position in accordance with rotation of the handle portion.

Preferably, the ring portion is detachably attached to the cylinder portion. In this case, the cylinder portion is separated from the ring portion by pulling the handle portion along the insertion section while setting the ring portion at the fixed position.

It is preferable that the ring portion is separated from the cylinder portion after the ring portion is moved to the fixed position and the handle portion is caused to rotate by at least a predetermined torque. In this case, it is preferable that the attachment jig is integrally molded from plastic, in which a thin-walled breaking portion is disposed between the ring portion and the cylinder portion.

When the handle portion is caused to rotate in a first direction by a torque below the predetermined level, the ring portion is moved to the fixed position without breaking the thin-walled breaking portion. When the handle portion is caused to rotate by a torque of at least the predetermined level at the fixed position, the thin-walled breaking portion is broken to form two broken surfaces.

Preferably, the thin-walled breaking portion has a saw-tooth shape, such that after the thin-walled breaking portion is broken, the two broken surfaces are not engaged with each other when the handle portion is caused to rotate in the first direction, and the two broken surfaces are engaged with each other when the handle portion is caused to rotate in a second direction opposite to the first direction. The thin-walled breaking portion having a saw-tooth shape consists of a plurality of straight grooves extending in an axial direction of the cylinder portion, a plurality of diagonal grooves, and a circular arc groove extending in a circumferential direction of the cylinder portion and connecting the straight groove and the diagonal groove adjacent to each other.

According to the attachment jig of the present invention, the ring portion is separably disposed at the cylinder portion rotated by the handle portion. Therefore, after the cylinder portion is inserted into a gap formed between the insertion section of the endoscope and the self-propelled device, the handle portion is rotated, and thereby the ring portion can be pushed into the fixed position. The ring portion is separated from the cylinder portion at the fixed position where the self-propelled device is fixed to the insertion section, and then the cylinder portion can be taken out from the insertion section while leaving the ring portion at the fixed position. Accordingly, since it is sufficient to manipulate the handle portion, the attachment operation for fixing the self-propelled device to the insertion section is easy.

Further, since the cylinder portion can be engaged with the ring portion, the handle portion is rotated after the cylinder portion is fit into the insertion section, such that the ring portion is moved from the fixed position, so as to cancel the fixation of the self-propelled device. Consequently, it is easy to detach the self-propelled device from the endoscope.

Furthermore, since the attachment jig of the present invention consists of the handle portion, the cylinder portion, and the ring portion, the structure of the attachment jig is simple. Therefore, it is possible to provide the attachment jig of the present invention at low cost.

### BRIEF DESCRIPTION OF THE DRAWINGS

The above object and advantages can be easily understood by those skilled in the art by reading the detailed description of the preferred embodiments of the present invention with reference to the attached drawings:

FIG. 1 is a schematic view of an endoscope equipped with an self-propelled device;

FIG. 2 is a cross-sectional view of the self-propelled device;

FIG. 3 is a perspective view showing an attachment jig and the self-propelled device;

FIG. 4 is a cross-sectional view of the attachment jig;

FIG. 5 is a partial enlarged view describing a thin-walled breaking portion;

FIG. 6 is a flowchart describing attachment and detachment of the self-propelled device;

FIG. 7 is a view showing an insertion section of the endoscope inserted through the self-propelled device, in which the insertion section is illustrated in a perspective manner as a matter of convenience;

FIG. 8 is a view in which the self-propelled device is fixed to a tip end rigid portion of the endoscope by the attachment jig;

FIG. 9 is a schematic view showing a state where the thin-walled breaking portion is broken and a ring portion is separated from the attachment jig;

FIG. 10 is an explanatory view showing a state where the attachment jig is engaged with the ring portion attached to the self-propelled device;

FIG. 11 is a perspective view showing an attachment jig according to another embodiment; and

FIG. 12 is a side view showing a state where a ring portion is separated from the attachment jig of FIG. 11.

### DESCRIPTION OF THE PREFERRED EMBODIMENTS

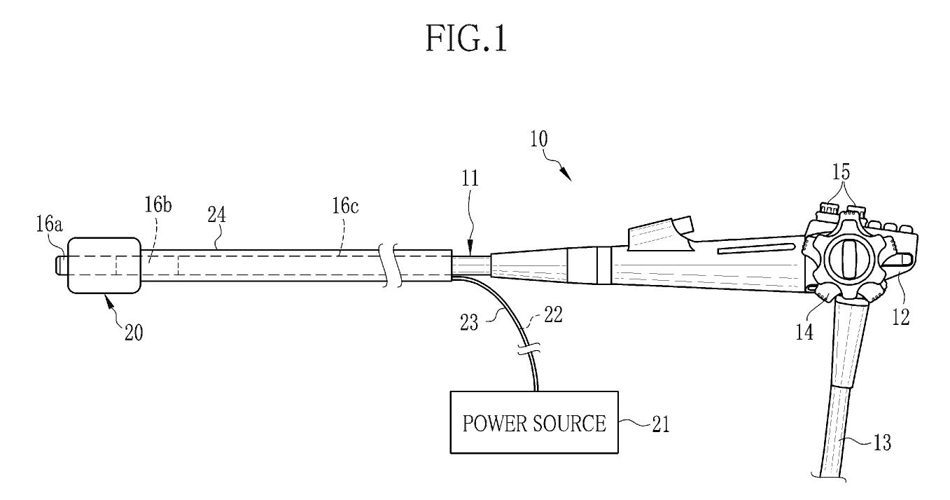

As shown in FIG. 1, an endoscope 10 consists of an insertion section 11 to be inserted into alimentary canals such as the large intestine, a manipulation section 12 used for the gripping of the endoscope 10 and the manipulation of the insertion section 11, and a universal cord 13 for connecting the endoscope 10 to a processor device and a light source device (not shown). The insertion section 11 includes a tip end rigid portion 16a, a bending portion 16b, and a flexible tube portion 16c. A solid-state image sensing device (a CCD sensor, a CMOS sensor, or the like) is incorporated into the tip end rigid portion 16a. The universal cord 13 contains an air/water supply channel, a cable for outputting imaging signals, and a light guide. The manipulation section 12 includes a pair of angle knobs 14 and a plurality of manipulation buttons 15.

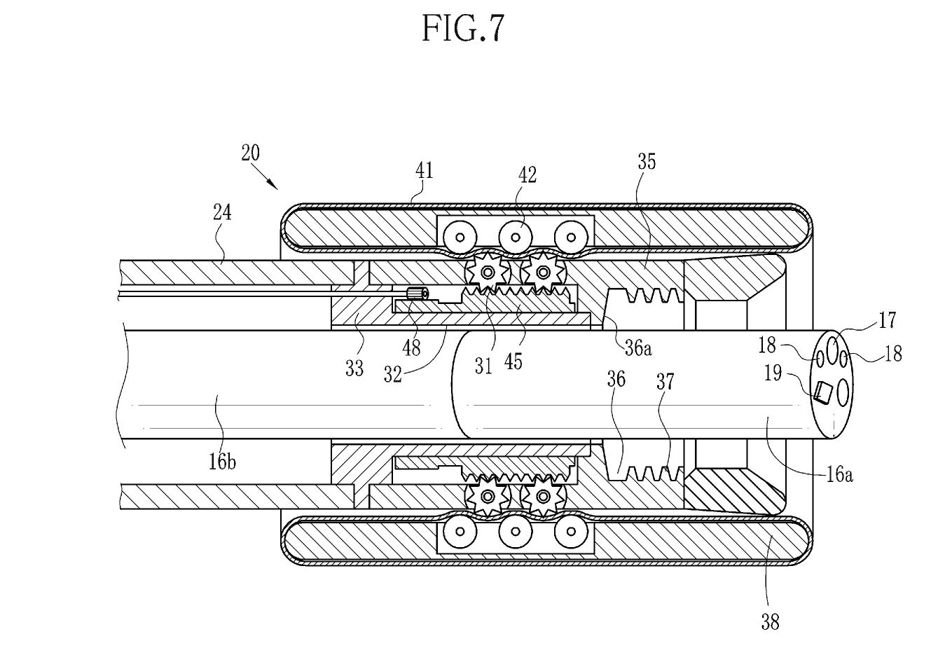

Each of the angle knobs 14 is manipulated to rotate at the time of bending the bending portion 16b in a vertical direction and a horizontal direction. In accordance with the rotational amount of the angle knob 14, the bending direction of the bending portion 16b is defined. The respective manipulation buttons 15 are used for various kinds of manipulation, such as supplying air, supplying water, and suctioning. The flexible tube portion 16c is a flexible rod-shaped member. An image capturing window 17, illumination windows 18, an air/water nozzle 19, and the like are provided at a front face of the tip end rigid portion 16a as shown in FIG. 7. The self-propelled device 20 is attached to the tip end of the insertion section 11, for example, the tip end rigid portion 16a, and thereby, the insertion section 11 is advanced within the body cavity such as an alimentary canal. The self-propelled device 20 is driven by a power source 21. The power source 21 has a motor and a motor controller. A torque wire 22 for transmitting rotary torque for moving the self-propelled device 20 is coupled to the motor. The torque wire 22 is covered with a protective sheath 23 over almost its entire length, and rotated within the protective sheath 23.

The motor controller of the power source 21 is connected to an operation unit (not shown). If operation signals for advancing, retracting, and stopping, and speed change signals from the operation unit are input to the motor controller, the driving of the motor is controlled according to these signals. A soft overtube 24 having high flexibility is connected to the self-propelled device 20, and the torque wire 22 is passed through the inside of the overtube 24 together with the sheath 23.

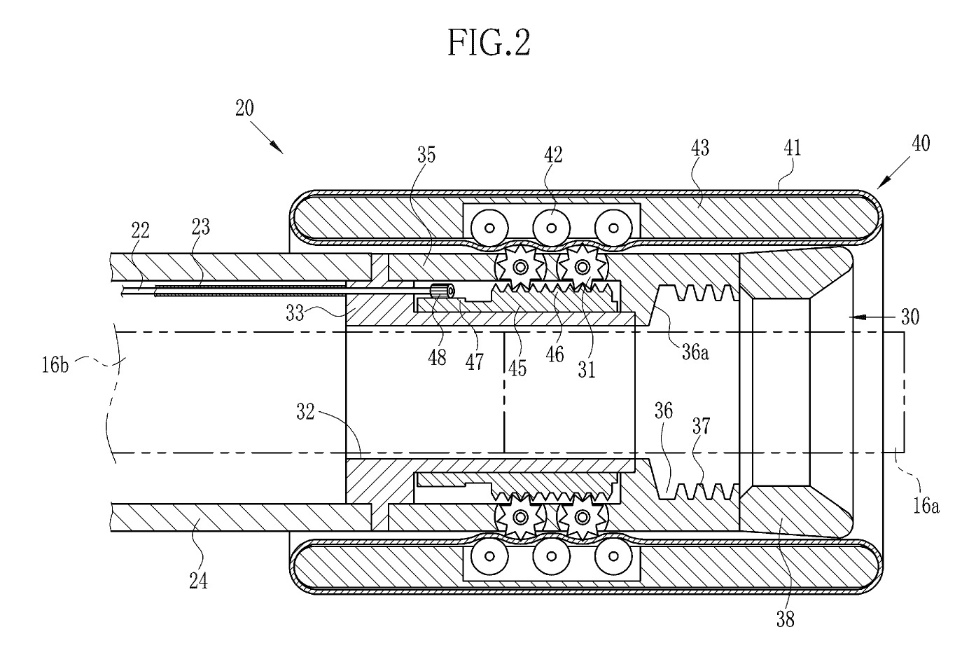

As shown in FIG. 2, the self-propelled device 20 includes a driving unit 30 having a tubular shape as a whole, and a tubular toroid unit 40 that is combined with the driving unit 30 so as to cover the outer peripheral side thereof. The driving unit 30 has an internal cylinder 33, a rotating cylinder 45 rotatably supported at an outer periphery of the internal cylinder 33, and an external cylinder 35 that rotatably supports driving wheels 31 and is fixed to the internal cylinder 33 so as to cover the rotating cylinder 45. A spur gear 47 is formed along an outer periphery at one end of the rotating cylinder 45, and a worm gear 46 is formed from a central portion of the rotating cylinder 45 to the other end thereof. A driving gear 48 fixed to the front end of the torque wire 22 meshes with the spur gear 47, and the driving wheels 31 mesh with the worm gear 46. Note that, each of the driving wheels 31 of an actual product has low teeth, and has a shape of concave-convex roller.

The toroid unit 40 has a bag body 41 formed of a thin film sheet having elasticity and flexibility in a toroid shape, and a cylindrical roller support cylinder 43 that is arranged in an internal space of the bag body 41 and rotatably supports driven rollers 42. The driven rollers 42 come into contact with an inner surface on the inner peripheral side of the bag body 41, pinch the bag body 41 between the driven rollers 42 and the driving wheels 31, and transmit the rotation of the driving wheels 31 to the bag body 41.

If the driving gear 48 is rotated by the rotary torque of the torque wire 22, the rotating cylinder 45 rotates in conjunction with the rotation of the driving gear 48. If the worm gear 46 rotates together with the rotation of the rotating cylinder 45, the driving wheels 31 meshing with the worm gear 46 rotate. Since the driving wheels 31 pinch the bag body 41 between the driving wheels 31 and the driven rollers 42, the driven rollers 42 rotate together with the rotation of the driving wheels 31, and the bag body 41 receives the rotative forces of the driving wheels 31 on its inner peripheral side and performs a circulation movement in the axial direction as a whole. Since the surface on the outer peripheral side of the bag body 41 comes into contact with the inner wall of the body cavity, propulsive force in an advance direction or a retract direction is applied to the tip end rigid portion 16a depending on the movement direction of the bag body 41.

A hollow portion of the internal cylinder 33 is used as an insertion hole 32 that allows the tip end rigid portion 16a to pass therethrough. The tip end rigid portion 16a is inserted into the insertion hole 32 from the rear end side of the internal cylinder 33. The self-propelled device 20 is fixed to an outer peripheral surface of the tip end rigid portion 16a in a state where the tip end of the tip end rigid portion 16a is made to protrude from the front end of the internal cylinder 33. The external cylinder 35 is fixed to the internal cylinder 33, and the external cylinder 35 protrudes toward the front end more than the internal cylinder 33. An internal thread 37 is formed in an inner peripheral surface of the external cylinder 35, and a concave portion 36 is formed at the rear end of the internal thread 37. A receiving plane 36a having a diameter decreasing toward the backward is continuously provided to the concave portion 36 in an annular manner. A ring 38 made of an elastic material such as rubber is fixed to the front end of the external cylinder 35. The ring 38 reduces a gap between the external cylinder 35 and the bag body 41.

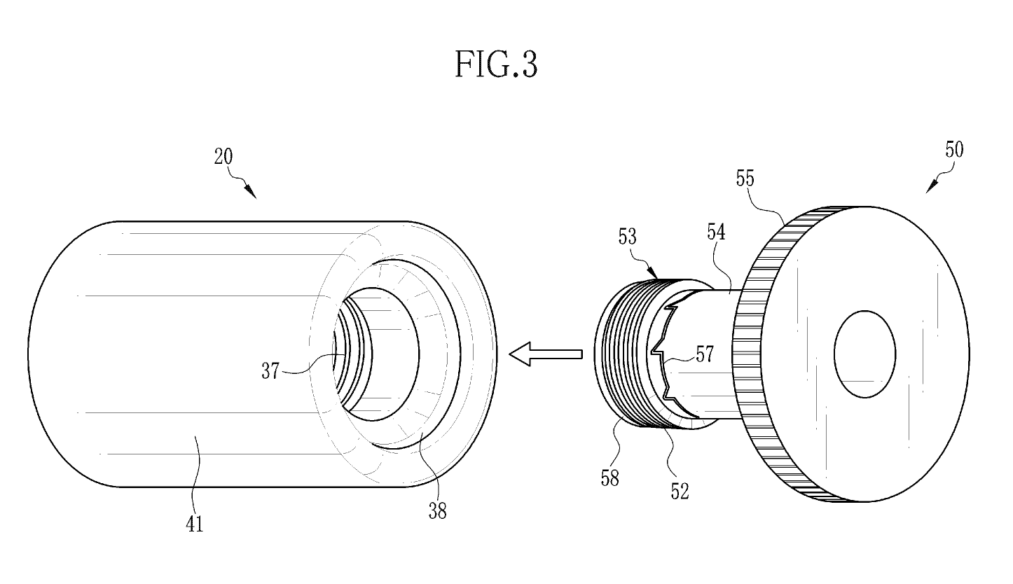

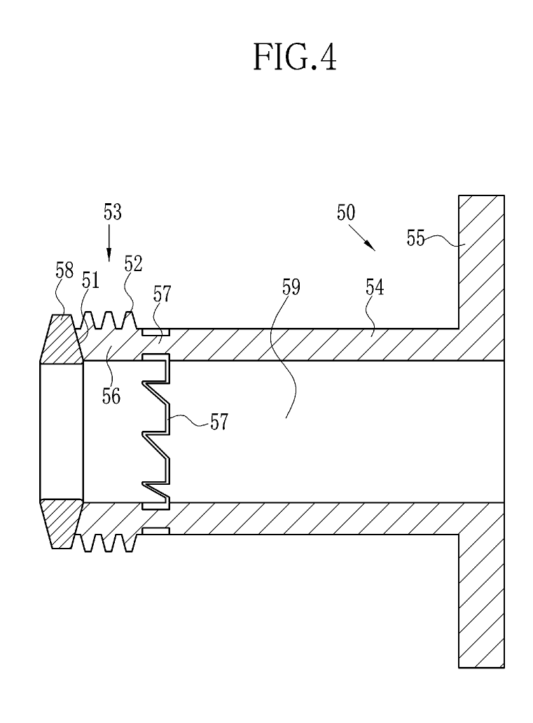

When the self-propelled device 20 is fixed to the tip end rigid portion 16a of the endoscope, a plastic attachment jig 50 is used, as shown in FIGS. 3 and 4. The attachment jig 50 includes a handle portion 55 having a large diameter, a cylinder portion 54, and a cylindrical ring portion 53. The ring portion 53 includes a tubular body 56 integrally molded with the cylinder portion 54, and an O ring 58 held by a pressing plane 51 of a front end portion of the tubular body 56. The O ring 58 is made of a material having high elasticity, such as rubber, and has a substantially trapezoidal cross-section. The pressing plane 51 is formed as a reversed inclined plane so as to become symmetrical to the receiving plane 36a formed in the external cylinder 35 of the self-propelled device 20. Note that, instead of the O-ring 58, a plurality of segments constituting one O-ring may be used.

An outer peripheral surface of the tubular body 56 is provided with an external thread 52 threadedly engaged with the internal thread 37 formed at the inner periphery of the external cylinder 35 of the self-propelled device 20. The external diameters of the cylinder portion 54 and the O ring 58 are smaller than the internal diameter of the external cylinder 35. Accordingly, the attachment jig 50 can be inserted into the self-propelled device 20 from the front end side thereof, and after the external thread 52 is threadedly engaged with the internal thread 37, the attachment jig 50 can be screwed into the self-propelled device 20 by turning the handle portion 55. Moreover, the internal diameters of the cylinder portion 54, the tubular body 56, and the O ring 58 are made larger than the external diameter of the tip end rigid portion 16a of the endoscope. Accordingly, even in a state where the tip end rigid portion 16a is made to protrude from the front end side of the self-propelled device 20 as shown in FIG. 2, the tip end rigid portion 16a can be fit into a hollow portion 59 that penetrates from the O ring 58 to the cylinder portion 54. It is thus possible to perform screwing manipulation of the attachment jig 50 by turning the handle portion 55.

A thin-walled breaking portion 57 is formed at the boundary between the tubular body 56 of the ring portion 53 and the cylinder portion 54. The thin-walled breaking portion 57 can be easily made without conducting post-processing by performing working for molding a thin-walled portion, on a molding die for obtaining a molded article before assembling the O ring 58, that is, a molded article in which the handle portion 55, the cylinder portion 54 and the tubular body 56 are integrated together. The thin-walled breaking portion 57 is provided over the whole circumference of the cylinder portion 54, and breaks when torque of at least a predetermined level is applied between the cylinder portion 54 and the tubular body 56.

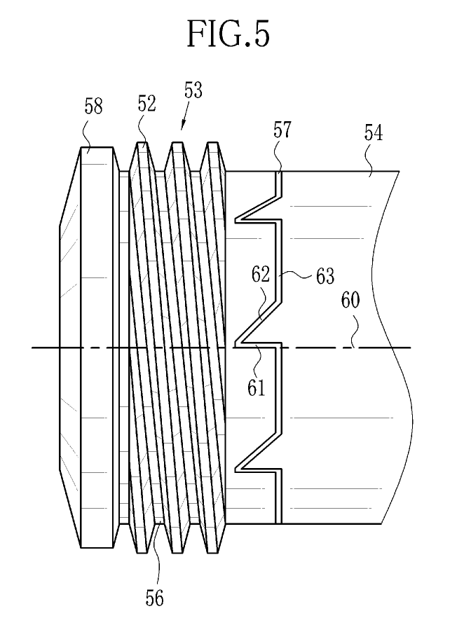

As shown in FIG. 5, the shape pattern of the thin-walled breaking portion 57 is a saw-toothed pattern in which a straight groove 61 extending in the direction of a central axis 60 of the cylinder portion 54, a diagonal groove 62, and a circular arc groove 63 are sequentially connected. The diagonal groove 62 inclines in a direction, in which, if the cylinder portion 54 and the tubular body 56 are broken at the thin-walled breaking portion 57 and then re-engaged with each other so as to rotate the cylinder portion 54 in the fastening direction of a right-hand screw, the tubular body 56 and the cylinder portion 54 slip and the engagement therebetween is easily released. In addition, it is possible to provide a slit-like opening at a portion of the thin-walled breaking portion 57 in order to adjust the torque to a low value at the time when the thin-walled breaking portion 57 is broken, and also in this case, a molding die can be used.

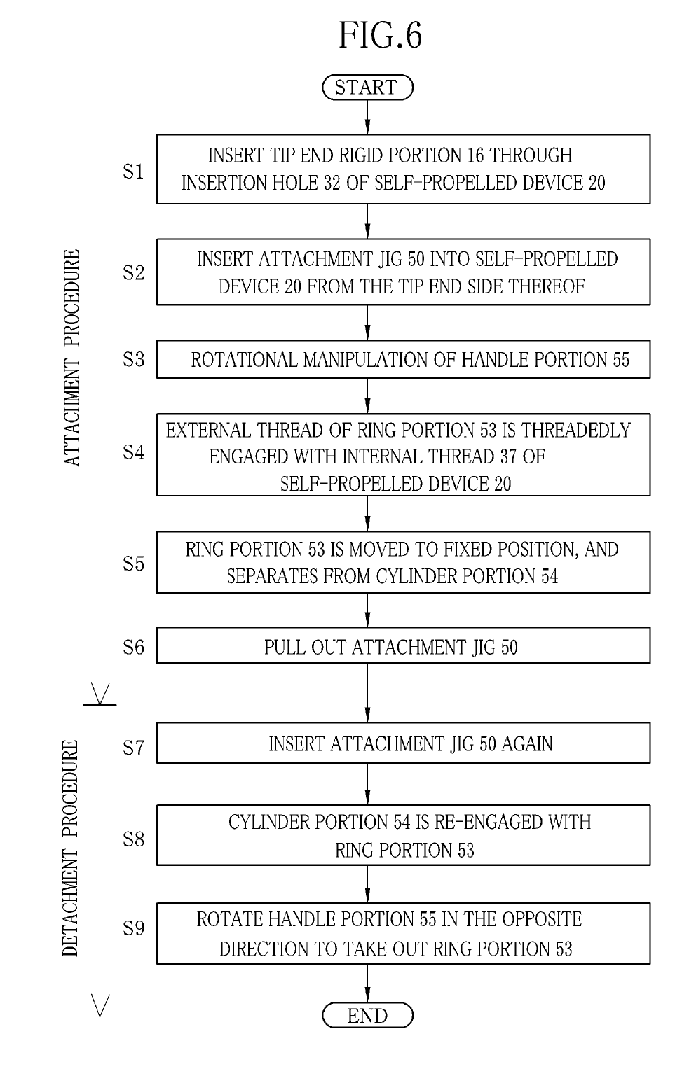

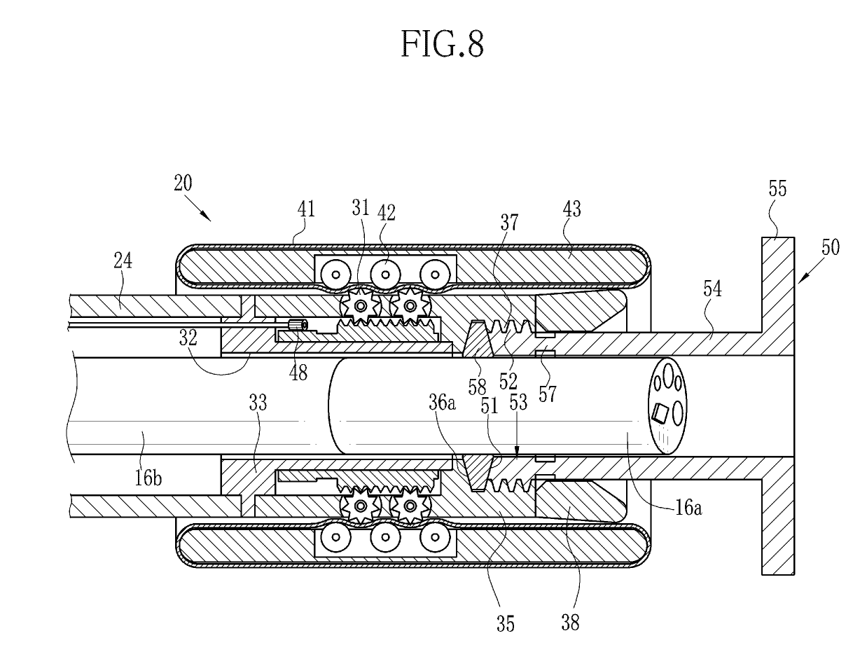

Next, an attachment procedure of the self-propelled device 20 using the attachment jig 50 will be described by referring to a flowchart shown in FIG. 6. At first, the tip end rigid portion 16a is inserted through the insertion hole 32 of the self-propelled device 20 as shown in FIG. 7. Next, as shown in FIG. 8, the attachment jig 50 that remains integrated with the ring portion 53 is put into the gap between the inner side of the external cylinder 35 and the outer periphery of the tip end rigid portion 16a, while the ring 38 is deformed.

If the handle portion 55 is turned in the clockwise direction (the fastening direction of a right-hand screw), the external thread 52 of the ring portion 53 is threadedly engaged with the internal thread 37 of the external cylinder 35. As the handle portion 55 is further turned in the same direction, the threaded engagement between the external thread 52 and the internal thread 37 is progressed. At this time, the O ring 58 is deformed, and passes through the internal thread 37, and then enters the receiving plane 36a. If the handle portion 55 continues to be turned, the ring portion 53 is further moved to the rear end side of the self-propelled device 20 by the threaded engagement between the internal thread 37 and the external thread 52, and the O ring 58 is crushed between the pressing plane 51 and the receiving plane 36a. Thereby, the internal diameter side of the O ring 58 is brought into press-contact with the outer peripheral surface of the tip end rigid portion 16a, and the self-propelled device 20 is fixed to the tip end rigid portion 16a.

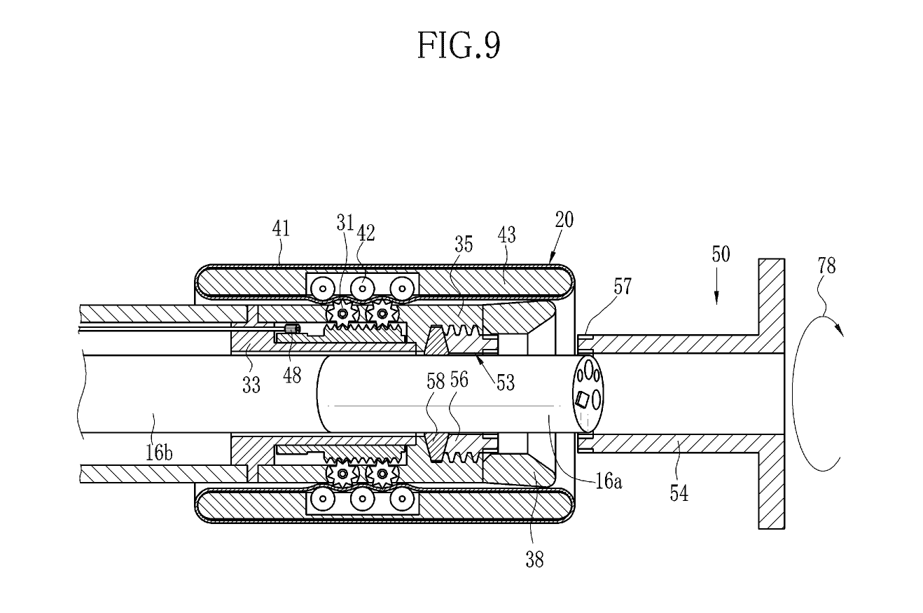

After the O ring 58 is brought into contact with the receiving plane 36a, if the handle portion 55 is further turned in a direction indicated by an arrow 78 such that a predetermined torque is applied, the thin-walled breaking portion 57 is broken and the ring portion 53 separates from the cylinder portion 54 as shown in FIG. 9. The ring portion 53 remains together with the O ring 58 between the self-propelled device 20 and the tip end rigid portion 16a, and the self-propelled device 20 is brought into a state of being attached to the tip end rigid portion 16a even if the cylinder portion 54 is pulled out.

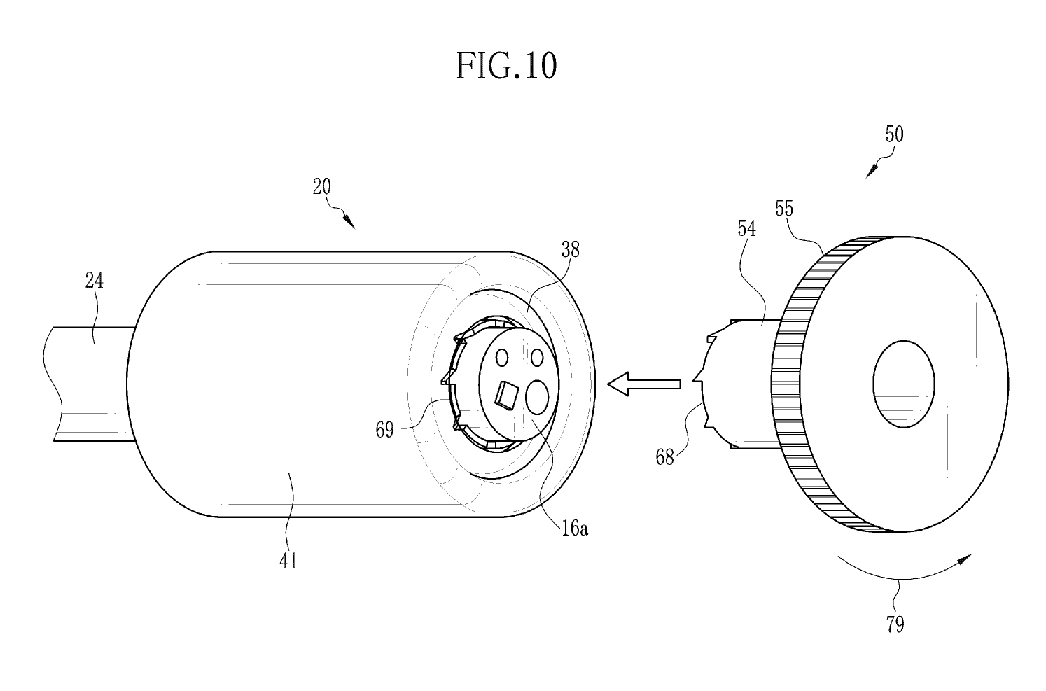

The following procedure is performed to detach the self-propelled device 20 from the tip end rigid portion 16a for the purpose of cleaning the endoscope 10. As shown in FIG. 10, after the thin-walled breaking portion 57 is broken, a first saw-toothed broken surface 68 is formed at the front end of the cylinder portion 54 in the attachment jig 50 from which the ring portion 53 is cut off. The ring portion 53 cut off from the thin-walled breaking portion 57 remains between the self-propelled device 20 and the tip end rigid portion 16a, and a second saw-toothed broken surface 69 is formed at the ring portion 53.

The cylinder portion 54 of the attachment jig 50 is inserted into the gap between the external cylinder 35 of the self-propelled device 20 and the tip end rigid portion 16a such that the first saw-toothed broken surface 68 and the second saw-toothed broken surface 69 are joined together, and then the handle portion 55 is turned in a direction indicated by an arrow 79. The respective straight grooves 61 of the first saw-toothed broken surface 68 and the second saw-toothed broken surface 69 engage with each other, the rotation of the handle portion 55 is transmitted to the ring portion 53, the external thread 52 comes off from the internal thread 37, and the ring portion 53 comes off the external cylinder 35. Since the O ring 58 is anchored to the pressing plane 51, the O ring 58 comes off together with the ring portion 53.

Thereby, the self-propelled device 20 can be detached from the tip end rigid portion 16a. Furthermore, even if the O ring 58 remains within the concave portion 36 when the ring portion 53 is detached, since a state where the O ring is pinched and pressed is released, the O ring 58 is not brought into press-contact with the outer peripheral surface of the tip end rigid portion 16a. Accordingly, the self-propelled device 20 can be detached from the tip end rigid portion 16a.

In order to couple the ring portion 53 to the external cylinder 35 of the self-propelled device 20, instead of utilizing the threaded engagement between the internal thread 37 and the external thread 52, it is also possible to make the ring portion 53 engage with the external cylinder 35 using a bayonet structure.

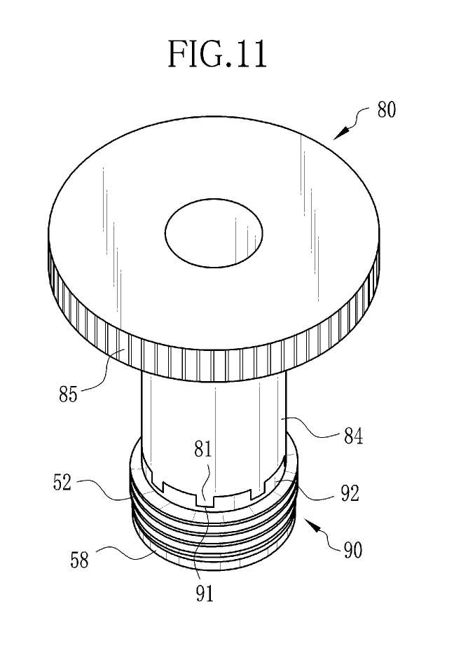

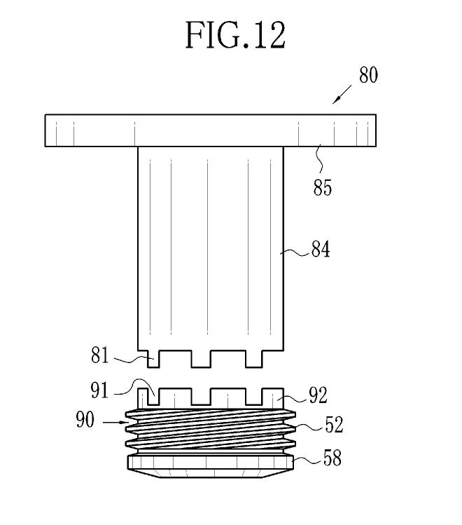

In the above embodiment, the ring portion 53 is separated from the attachment jig 50 by moving the ring portion 53 to a fixed position, fixing the self-propelled device 20 to the tip end rigid portion 16a, and then further rotating the cylinder portion 54 beyond a predetermined torque to break the thin-walled breaking portion 57. However, as shown in FIGS. 11 and 12, an external force may be applied in an axial direction such that the ring portion is separated.

An attachment jig 80 shown in FIGS. 11 and 12 includes a cylinder portion 84 with one end of which a handle portion 85 is integrated, and a front end portion of the cylinder portion 84 is provided with engaging projections 81 aligned in the shape of comb teeth. A ring portion 90 for fixing the self-propelled device 20 to the tip end rigid portion 16a is the same as the ring portion 53 of the above embodiment, except that recesses 91 into which the engaging projections 81 fit are formed and aligned at the rear end of a tubular body 92. The O ring 58 is held on the front end side of the tubular body 92, and the external thread 52 is provided at an outer periphery of the tubular body 92. The engaging projections 81 and the recesses 91 are coupled together by fitting by press-fitting, and can be handled as an integral attachment jig 80 after being fitted to each other.

In exactly the same manner as the aforementioned attachment jig 50, the attachment jig 80 can be manipulated to rotate in one direction to move the ring portion 90 to a fixed position, and the self-propelled device 20 can be fixed to the tip end rigid portion 16a using the elastic force of the O ring 58. After the handle portion 85 is manipulated to rotate so as to apply a sufficient torque, the handle portion 85 is pulled in the axial direction. If this tension becomes larger than the press-in force between the engaging projections 81 and the recesses 91, the tubular body 92 separates from the cylinder portion 84, and the cylinder portion 84 is extracted together with the handle portion 85, while the ring portion 90 remains at a fixed position where the self-propelled device 20 is fixed to the tip end rigid portion 16a.

In order to remove the ring portion 90, the handle portion 85 is gripped, the cylinder portion 84 is inserted into the inside of the self-propelled device 20, and the handle portion 85 is manipulated to rotate slowly while being lightly pressed. After the engaging projections 81 of the cylinder portion 84 coincide with the respective recesses 91, the engaging projections 81 are engaged with the recesses 91, such that the engaging projections 81 fit into the recesses 91. By strongly rotating the handle portion 85 in the opposite direction, the ring portion 90 in the fixed position can be taken out.

In this embodiment, the ring portion 90 can be re-engaged with the front end of the cylinder portion 84. Therefore, after the ring portion 90 is detached once to be washed and disinfected, and if necessary, the O ring 58 is replaced with new one, the ring portion 90 can be attached again to the cylinder portion 84. Thus, it is possible to reuse the ring portion 90.

Although the configuration in which the O ring 58 is brought into press-contact with the insertion section of the endoscope so as to fix the self-propelled device 20 is adopted in the above-mentioned embodiments, the other structures may be adopted. For example, there may be adopted a so-called pin-vice structure in which the external cylinder 35 of the self-propelled device 20 is formed with an arm that is bent in an axial center direction to chuck the ring portion 53, and the arm is pressed in the axial center direction with an attachment jig so as to fix the self-propelled device to the insertion section.

Further, the handle portion may have a cross-like shape instead of the discoid shape.

In the present invention, various alterations and modifications can be made without departing from the spirit of the present invention and such alterations and modifications should also be interpreted as being included in the scope of protection of the present invention.

What is claimed is:

1. An attachment jig for use in fixing a self-propelled device to a tip end of an insertion section of an endscope, said attachment jig comprising:
a cylinder portion to be inserted into a gap formed between an outer peripheral surface of said insertion section and an inner peripheral surface of said self-propelled device from the tip end side of said insertion section, in a state that said insertion section is inserted into said self-propelled device;
a ring portion separably provided at a first end of said cylinder portion, said ring portion fixing said self-propelled device to said insertion section at a fixed position; and
a handle portion provided at a second end of said cylinder portion, said handle portion serving for moving said ring portion to said fixed position, separating said ring portion from said cylinder portion at said fixed position, and taking out said cylinder portion from said insertion section while leaving said ring portion at said fixed position.

2. The attachment jig according to claim 1, wherein said insertion section has a tip end rigid portion at its tip end, and said self-propelled device is fixed to said tip end rigid portion with the intermediation of said ring portion.

3. The attachment jig according to claim 2, wherein said ring portion has an elastic member attached to its front end, and said elastic member is pinched between said ring portion and a part of said self-propelled device and elastically deformed at said fixed position so as to be pressed against an outer peripheral surface of said tip end rigid portion.

4. The attachment jig according to claim 3, wherein said elastic member is an O ring made of rubber.

5. The attachment jig according to claim 3, further comprising an external thread formed at an outer periphery of said cylinder portion, said external thread being threadedly engaged with an internal thread formed at the inner peripheral surface of said self-propelled device, such that said cylinder portion becomes movable toward said fixed position in accordance with rotation of said handle portion.

6. The attachment jig according to claim 5, wherein said ring portion is detachably attached to said cylinder portion.

7. The attachment jig according to claim 6, wherein said cylinder portion is separated from said ring portion by pulling said handle portion along said insertion section while leaving said ring portion at said fixed position.

8. The attachment jig according to claim 5, wherein said ring portion is separated from said cylinder portion after said ring portion is moved to said fixed position and said handle portion is caused to rotate by at least a predetermined torque.

9. The attachment jig according to claim 8, wherein said attachment jig is integrally molded from plastic, in which a thin-walled breaking portion is disposed between said ring portion and said cylinder portion.

10. The attachment jig according to claim 9, wherein after said handle portion is caused to rotate in a first direction by a torque below the predetermined level such that said ring portion is moved to said fixed position, said handle portion is caused to rotate by a torque of at least the predetermined level at said fixed position such that said thin-walled breaking portion is broken to form two broken surfaces.

11. The attachment jig according to claim 10, wherein said thin-walled breaking portion has a saw-tooth shape, such that after said thin-walled breaking portion is broken, said two broken surfaces are not engaged with each other when said handle portion is caused to rotate in said first direction, and said two broken surfaces are engaged with each other when said handle portion is caused to rotate in a second direction opposite to said first direction.

12. The attachment jig according to claim 11, wherein said thin-walled breaking portion having a saw-tooth shape consists of a plurality of straight grooves extending in an axial direction of said cylinder portion, a plurality of diagonal grooves, and a circular arc groove extending in a circumferential direction of said cylinder portion and connecting said straight groove and said diagonal groove adjacent to each other.
